(19) United States
(12) Patent Application Publication
(10) Pub. No.: US 2010/0157285 A1
(43) Pub. Date: Jun. 24, 2010

(54) METHOD AND DEVICE FOR MONITORING A COMBUSTION PROCESS

(75) Inventors: Wilfried Hangauer, Rastatt (DE); Hans Link, Sinzheim (DE); Rainer Lochschmied, Rheinstetten-Forchheim (DE)

Correspondence Address: LERNER GREENBERG STEMER LLP, P O BOX 2480, HOLLYWOOD, FL, 33022-2480, US

(73) Assignee: SIEMENS BUILDING TECHNOLOGIES HVAC PRODUCTS GMBH, Rastatt (DE)

(21) Appl. No.: 12/376,374

(22) PCT Filed: Aug. 6, 2007
(86) PCT No.: PCT/EP2007/058151

§ 371 Date: Apr. 21, 2009

(30) Foreign Application Priority Data
Aug. 4, 2006 (DE) 10 2006 036 563.1

(51) Int. Cl. G01N 21/35; G01N 21/39

(52) U.S. Cl. 356/51; 356/437

(57) ABSTRACT

A method for monitoring a combustion process in the infrared wavelength range includes using a laser, which transmits a laser light beam along a measurement path in a certain wavelength range, which is selected in such a way that a gas therein to be detected in the combustion process has an absorption line, and that the emission wavelength of the laser detects the absorption line of the gas to be detected upon the tuning in the selected wavelength range. The concentration of the gas is determined as a function of the absorbed energy of the laser light beam. The intensity of the laser light beam is detected and is analyzed in order to determine the existence of a flame in the combustion process, and/or the quality of the flame.

The invention relates to a method for monitoring a combustion process in the infrared wavelength range using a laser which transmits a laser beam along a measurement path in a specific wavelength range which is also selected so that a gas in the same to be detected in the combustion process has an absorption line and that the emission wave length of the laser detects the absorption line of the gas to be detected upon the tuning in the selected wavelength range, wherein the concentration of the gas is determined as a function of the absorbed energy of the laser light beam.

A method of the type mentioned at the outset is known for example from WO 01/33200 A1. This discloses a laser diode which transmits a collimated light beam in the near infrared wavelength range along a measurement path, with the light beam hitting a photo detector arranged in the beam entry of the laser diode. The absorption of the energy of the laser light beam which occurs here is spectrally evaluated in order to determine the concentration of the gases present in the combustion process. For example gas concentrations of oxygen, carbon dioxide, carbon monoxide, etc. occurring in a combustion process can be identified.

DE 103 04 455 B4 discloses a method for analysis of a gas mixture, in which a gas mixture is analyzed by means of laser spectroscopy. Laser spectroscopy methods are also used for determining combustion values of natural gases.

A method for determining combustion values of natural gas by means of absorption spectroscopy in the infrared wavelength range using a laser diode is known from EP 1 174 705 B1 for example.

EP 0 838 636 A2 also discloses a method for controlling a natural gas-operated heat energy device, in which a light beam created by a diode laser is introduced into the combustion gas supplied and the degree of energy absorption varying with changing gas compositions is detected. The reaction conditions of the heat energy device are then regulated as a function of the respective absorption values detected.

The methods known from the prior art show that the gas molecules occurring in a combustion process can be determined qualitatively and quantitatively with the aid of absorption spectroscopy. In such cases photons in the infrared spectral range are absorbed from the incident light beam into the gas molecules. In the spectrum the absorption of the photons manifests itself by absorption lines. Different gas molecules in this case show individual spectral or absorption lines both in relation to their strength and also their position in the spectrum. This enables gas molecules to be detected on the basis of their characteristic spectrum. In this case radiographic sources with a narrow line width are used, so that the absorption lines are able to be resolved as well as possible. Typically lasers are used as light sources which are able to be tuned with their monochromatic emission spectra to the spectral lines or the absorption lines of the gas molecules to be detected. With current methods employed in heating systems for monitoring the combustion process diverse monitoring sensors are required as a rule to ensure that the quantities or air and gas required for combustion are available and that the combustion process executes correctly. For monitoring the combustion process, the gas pressure, the air pressure and also the cooling air flow are monitored in particular, during the startup of the burner for example. Overpressure and underpressure watchdogs are used for monitoring the gas pressure for example. These ensure that the mains pressure of the combustion gas neither exceeds nor falls below the allowed limits. For monitoring the air pressure created by the burner fan, pressure nozzles are used for example, which are installed in the inlet air duct of the burner. The monitoring sensors cut in if a fault occurs, e.g. on failure of the fan motor, in order to avoid rough impermissible combustion states. The fault is signaled to an automatic firing system for example, which initiates a switching off of the burner of the heating system.

So that the safety requirements for burners are fulfilled it is also necessary to monitor the flame for example during the ignition of the fuel and also during operation of the burner. Optical methods are used for example for monitoring the flame, with the presence of the flame being established by its optical radiation being evaluated. A further known method for flame monitoring consists of detecting the ionization stream of the flame with an ionization electrode projecting into the flame and evaluating this to determine the existence of the flame.

So that the concentration of pollutants is as low as possible and the energy efficiency as high as possible in the combustion process, the combustion quality will also be monitored ever more frequently.

This manifests itself for example in the composition of the gases occurring in the combustion process, such as oxygen, carbon dioxide, carbon monoxide for example. For monitoring the quality of the combustion process in burners, special sensors are used for gases occurring in the combustion process, which specify data such as the measured gas concentrations for example as percentages by volume of oxygen or carbon dioxide. With the aid of the percentages by volume determined the fuel/air mixture can be adjusted for example, which enables the quality of the combustion process to be continuously optimized. The purpose of the different sensors used for monitoring the combustion process is to keep the combustion in a hygienic or safe state, in which case a flame failure during the combustion process is to be detected immediately. In addition the efficiency is to be optimized.

The underlying object of the invention is to propose a method and a device for monitoring a combustion process which makes it possible safely and reliably and with little technical outlay to monitor the variables relevant for the combustion process. This object is achieved by the features of independent claims 1 and 10.

The invention is based on an infrared measurement-based laser spectroscopy, whereby, for detection of at least one gas present in the combustion process, a laser light source, especially a VCSEL laser, transmits a laser beam along a measurement path. In this case the laser light beam strikes a photodetector arranged at the end of the measurement path which detects the intensity of the received light beam.

The existence and/or quality of the flame are then established on the basis of the detected intensity of the light beam. For example the laser light beam passes through the flame to be monitored in the combustion area of the flame and additionally the optical radiation emitted by the flame can also be optically detected and evaluated to establish the existence and/or quality of the flame. Since the measurement is preferably in-situ and almost without inertia, a flame failure or a collapse of the flame can be detected immediately. Preferably the gas concentrations measured in each case are evaluated to establish the quality of the flame.

The advantage of the invention is that it is able to do without the previously normal UV, infrared sensors for flame monitoring. In addition there is no need for dynamometers to measure the air and gas pressure. The invention thus enables the combustion process to be monitored with little technical outlay, with all combustion and safety-relevant parameters taken into account.

Since the flames generally have propagation speeds of a few meters per second, a measurement gap from the flame of one meter already means a second of dead time in relation to the state of the flame. So that a state transition of the flame can be established sufficiently quickly as defined in the pertinent standards, the measurement is preferably made in-situ, i.e. in the vicinity of the flame or in the flame e.g. in the combustion area of the flame. This means that the dead time is negligible and it is ensured that, on flame failure during burning operation, it is possible to deactivate the fuel feed within the time demanded by the safety standard.

Since temperatures of more than 1000° C. occur in the flame, the measurement in the flame area requires a protection of the sensors used for this purpose, in particular the laser and the photo detector must be protected against the high temperatures in the flame area.

In accordance with a development of the invention this is achieved by the laser light beam being directed by optical fibers, for example through quartz glass rods from the laser to the photo detector, with the laser transmitting the laser light beam and the photodetector receiving the laser light beam then being able to be positioned remotely from the flame. Since the laser light beam is not influenced optically by the quartz glass rod, the measurement result is unaffected by the length of the quartz glass rod. This has the advantage of enabling the laser used for measurement and the photo detector to be positioned remotely from the flame, which also offers advantages for the mechanical design of the device.

Preferably the invention is used for monitoring different phases of a burner cycle of a heating system and especially for monitoring the gas concentrations arising in such cases, for example of oxygen, carbon dioxide, etc.

A further object of the invention consists of preparing the measured values obtained by means a laser spectroscopy for the monitoring in such a way that these are also able to be used for controlling a burner.

This object is achieved by converting into relative measured values the absolute measured values obtained during monitoring using the temperature detected in the measurement path.

Preferably a temperature sensor, e.g. a thermoelement, is integrated into the measurement path. The temperature sensor preferably takes its measurements in the area of the flame, which has the advantage of enabling the temperature signal to also be used for establishing the existence and/or the quality of the flame. The fact that the evaluation of the temperature signal is independent of the optical flame evaluation also enables the reliability of the flame evaluation to be enhanced.

With the aid of the measured temperature the gas density, and from this the relative gas concentration, can also be determined. The fact that the temperature is measured in-situ means that the conversion of the absolute measured gas concentration into the relative gas concentration is independent of the gas density. This makes a density-independent combustion control possible.

The regulation of the individual phases of a burner cycle is preferably undertaken with reference to the measured oxygen concentration, with the following setpoint values able to be used.

For standby operation for example the setpoint value can be greater than 19 percent by volume of O₂. For the phase of pre-ventilation the setpoint value can for example be greater than 20.5 percent by volume of O₂. For the phase of assignment the setpoint value is for example less than or equal to 10 percent by volume of O₂. For normal burner operation the setpoint value can be less than or equal to 6 percent by volume of O₂. For the decommissioning phase a setpoint value of greater than or equal to 18 percent by volume of O₂ can be selected. Naturally other setpoint values can be used as a basis for control, depending on the type of burner and the type of fuel.

The invention also makes it possible, starting from the measured temperature, for the water or water vapor content to be determined. With the aid of the measured temperature, with a known fuel, the moisture content and the gas concentration can be specified in relation to a dry exhaust gas for example.

Further advantages of the invention emerge from the subsequent description and are the subject matter of the dependent claims.

The invention will be explained in greater detail below with reference to schematic drawings of exemplary embodiments. The figures are as follows:

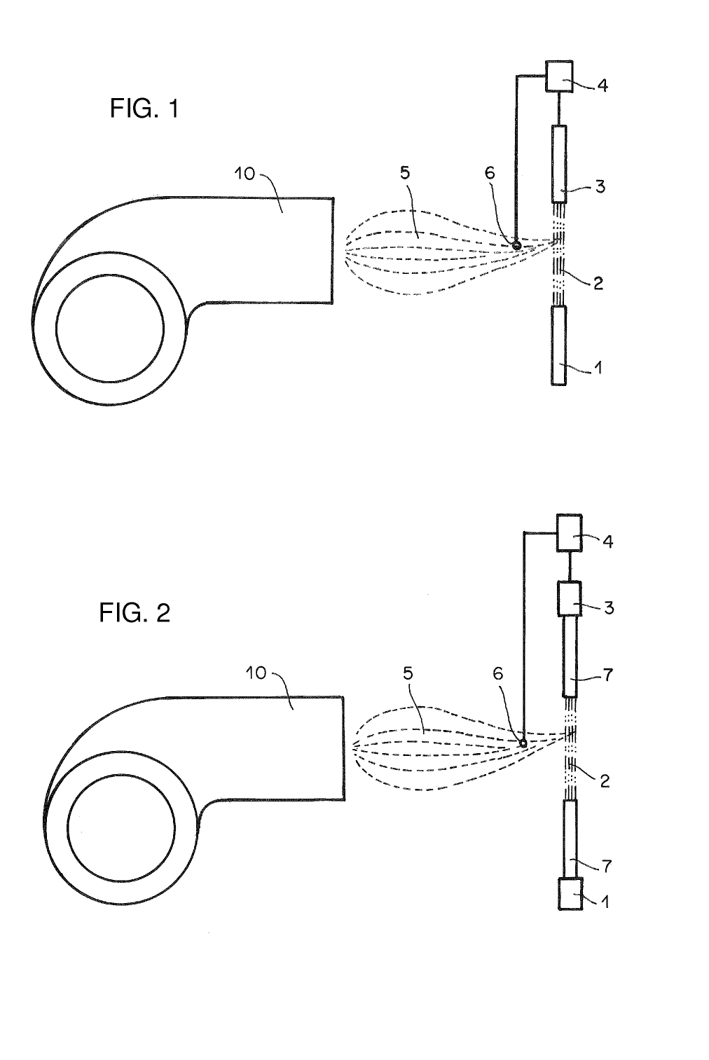

FIG. 1: a first exemplary embodiment of a device for monitoring a gas combustion process,

FIG. 2: an embodiment modified compared to FIG. 1,

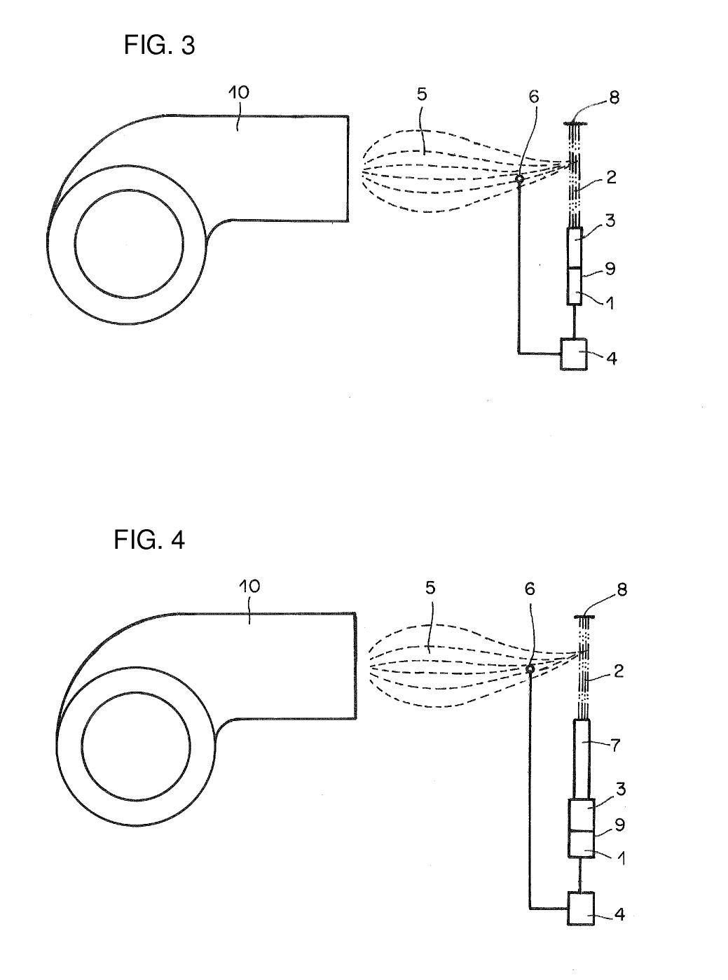

FIG. 3: a second exemplary embodiment of a device for monitoring a gas combustion process,

FIG. 4: an embodiment modified compared to FIG. 3,

FIG. 1 shows, in the form of a block diagram, the device for monitoring a gas combustion process. The device comprises a laser light source 1, for example a Vertical Cavity Surface Emitting Laser, abbreviated to VCSEL. This does not need any external optics itself, which means that parts needing critical adjustment, such as the coupler, are omitted, which makes the VCSEL laser insensitive to mechanical shocks. Because of its robustness the VCSEL laser is well suited to monitoring a combustion process. In this case the narrowband nature of the laser light beam and its high spectral power are especially advantageous. The absorption lines for detecting of oxygen or carbon dioxide lie for example at 760 or 1570 nanometers. A part of the energy of the transmitted laser light beam 2 is picked up in this case by absorption of the corresponding gas molecules. As a result the light beam 2 transmitted by the laser light source 1 hits the photodetector 3 arranged at the end of the measurement path with a reduced intensity.

Naturally a so-called Quantum Cascade Laser, abbreviated to QCL, can also be used. This has the advantage that its emission wavelength can also be freely selected in the mid and far infrared range. In this case the laser light source 1 is selected so that the laser light beam 2 transmitted along a measurement path has a specific wavelength range in the Infrared spectrum, in which gas to be detected exhibits a characteristic spectral or absorption line.

A flame 5 created by a burner 10 extends for example at its end into the measurement path, with the light radiation emitted by the flame 5 likewise striking the photodetector 3. Preferably a wideband photodetector 3 is used which detects the laser light radiation 2 and the light radiation originating from the flame 5. The photodetector preferably delivers a measuring signal proportional to the received light intensity, e.g. a photo stream which is evaluated by a signal evaluation device 4. The evaluation device 4 features a transimpedance amplifier for example which converts the photostream into a voltage. The evaluation device 4 can also feature a lock-in amplifier which filters the voltage obtained from the transimpedance amplifier. The detected light beam of the flame can also be evaluated spectrally by the evaluation device 4. The evaluation device 4 can for example be a component of the automatic firing system of a burner 10.

Preferably a temperature sensor 6 which detects the temperature arising in the flame 5, for example a thermoelement 6 in the measurement path, is typically arranged in the area of the flame 5. The temperature signal is fed to the evaluation device 4 which can then evaluate this together with the optical measuring signals to establish the existence and/or the quality of the flame.

With the aid of the measured temperature the gas density can also be detected, and on the basis of this the absolute measured gas concentration can then be converted into a relative gas concentration. The conversion has the advantage that the relative gas concentration, e.g. percentages by volume of oxygen, can be used directly for controlling the burner 10.

The conversion of the absolute measured values into relative measured values is however not absolutely necessary for the monitoring of the gas combustion process. The respective absolute measured gas concentration, e.g. the number of oxygen molecules and/or of carbon dioxide molecules, can also be evaluated just as well without conversion for establishing the existence and/or the quality of the flame.

FIGS. 2 to 4 each show a modified embodiment of the invention depicted in FIG. 1. The same elements are provided with the same reference symbols, so that corresponding reference can be made to the description in conjunction with FIG. 1. The embodiment in accordance with FIG. 2 additionally features the optical fiber 7. The light beam 2 transmitted by the laser light source 1 arrives via the optical fiber 7 at the photodetector 3. The optical fibers 7 are for example quartz glass rods, which are resistant to the heat of the temperatures of more than 1000° C. occurring in the flame area. With the aid of the quartz glass rods 7 the laser 1 and the photodetector 3 can be positioned remotely from the flame 5. Since the laser light beam 2 is not optically influenced by the quartz glass rods 7 the measurement is independent of the length of the quartz glass rods. The optical fibers 7 enable the laser 1 and the photodetector 3 to be positioned remotely from the flame 5, which protects them from the heat of the flame 5. The shape of the optical fibers 7 can also be bent or angled, which simplifies the positioning of the laser and of the photodetector in the device.

FIG. 3 shows a further exemplary embodiment of a device for monitoring the combustion process which additionally features a reflector 8. The reflector 8 reflects the light beam 2 transmitted by the laser light source 1 such that said beam hits the photodetector 3 which is then evaluated by the evaluation device 4. This arrangement of laser 1 and photodetector 3 offers the advantage that these units can be accommodated in a sensor housing 9.

FIG. 4 shows a modified embodiment of FIG. 3. The embodiment in accordance with FIG. 4 needs only one optical fiber 7. The light beam 2 transmitted by the laser light source 1 travels via the optical fiber 7 to the reflector 8. The light beam reflected by the reflector 8 then travels via the optical fiber 7 to the photodetector 3. The use of the reflector 8 enables the transmitter 1 and receiver 3 to be accommodated in one sensor housing 9 which means that only one optical fiber 7 is needed. Naturally with this embodiment too the optical fibers 7 can have any form, with the sensor housing 9 accommodating the laser 1 and the photodetector 3 able to be positioned at the desired location in the device.

1-18. (canceled)

19. A method for monitoring a combustion process in the infrared wavelength range, the method comprising the following steps:
transmitting a laser beam from a laser along a measurement path in a specific wavelength range selected in such a way that a gas to be detected in the wavelength range in the combustion process has an absorption line and that an emission wavelength of the laser scans the absorption line of the gas to be detected upon tuning in the selected wavelength range;
determining a concentration of the gas in the combustion process as a function of an absorbed energy of the laser light beam; and
detecting and evaluating an intensity of the laser light beam for ascertaining at least one of an existence of a flame in the combustion process or a quality of the flame.

20. The method according to claim 19, which further comprises including the flame to be monitored in the measurement path, and detecting and evaluating light radiation emitted by the flame for ascertaining at least one of the existence of the flame or the quality of the flame.

21. The method according to claim 20, which further comprises providing an evaluation device, detecting a temperature in the measurement path, and evaluating a temperature signal of the evaluation device for ascertaining at least one of the existence or the quality of the flame.

22. The method according to claim 21, which further comprises carrying out the step of detecting the temperature in the measurement path in the area of the flame.

23. The method according to claim 21, which further comprises determining a concentration of the gas to be detected as a relative gas concentration on the basis of the detected temperature.

24. The method according to claim 19, wherein the gas to be detected is oxygen or carbon dioxide and the absorption line lies at a wavelength of 760 nanometers or 1570 nanometers.

25. The method according to claim 24, which further comprises carrying out the monitoring for different phases of the combustion process, and comparing the gas concentration determined for the respective phase with a setpoint value determined for the respective phase of the combustion process.

26. The method according to claim 25, wherein the different phases of the combustion process represent a burner cycle of a heating system and the setpoint values are determined in a learning cycle.

27. The method according to claim 26, wherein the burner cycle includes a standby phase, a prepurge phase, an ignition phase, an operating phase and a shutdown phase, with each phase of the burner having a setpoint value compared with the gas concentration determined for the respective phase.

28. The method according to claim 27, which further comprises turning off the burner if a setpoint value defined for the phase is exceeded or not reached.

29. A device for monitoring a combustion process, the device comprising:
a laser light source tunable in a specific wavelength range of infrared radiation and transmitting a laser light beam along a measurement path;
a photodetector disposed at an end of said measurement path for creating a measuring signal in dependence on said laser light beam received from said laser light source; and
an evaluation device receiving said measuring signal for determining a concentration of a gas to be detected in the combustion process, said evaluation device evaluating said measuring signal obtained from said photodetector to ascertain at least one of an existence of a flame or a quality of the flame in the combustion process.

30. The device according to claim 29, which further comprises at least one optical fiber guiding said laser light beam into an area of the flame, said photodetector detecting said laser light beam passing through the flame area, and said evaluation device evaluating said measuring signal delivered by said photodetector.

31. The device according to claim 30, which further comprises a further optical fiber guiding said laser light beam passing through the flame area onwards to said photodetector.

32. The device according to claim 29, which further comprises a reflector reflecting said transmitted laser light beam causing a reflected laser light beam to hit said photodetector.

33. The device according to claim 29, which further comprises a temperature sensor integrated into said measurement path for detecting a temperature and delivering a temperature signal for evaluation by said evaluation device to ascertain at least one of the existence or quality of the flame.

34. The device according to claim 33, wherein said temperature sensor is integrated into said measurement path in the area of the flame.

35. The device according to claim 33, wherein the device monitors a cycle of a burner of a heating system, and said evaluation device compares measured values determined for a respective phase of the burner with a setpoint value defined for the respective phase of the burner.

36. The device according to claim 35, wherein the device determines the setpoint values used for the different phases of the burner in a learning cycle.

37. The device according to claim 35, wherein said evaluation device causes the burner to be switched off if the value exceeds or drops below the setpoint value determined for the respective phase.

38. The device according to claim 29, wherein said laser light source is a VCSEL laser or a QCL laser.
